(19) United States
(12) Patent Application Publication
(10) Pub. No.: US 2013/0202919 A1
(43) Pub. Date: Aug. 8, 2013

(54) BATTERY PACK

(71) Applicant: SAMSUNG SDI CO., LTD., Yongin-si (KR)

(72) Inventor: Ho-Ryong HWANG, Yongin-si (KR)

(73) Assignee: SAMSUNG SDI CO., LTD., Yongin-si (KR)

(21) Appl. No.: 13/756,781

(22) Filed: Feb. 1, 2013

(30) Foreign Application Priority Data
Feb. 3, 2012 (KR) 10-2012-0011172

(51) Int. Cl. H01M 2/20

(52) U.S. Cl. CPC H01M 2/202; H01M 2/204; H01M 2/206
USPC 429/7

(57) ABSTRACT

A battery pack includes a plurality of battery cells having electrodes and arranged parallel to each other, a holder case accommodating the plurality of battery cells, a protective circuit module mounted on an outer surface of the holder case, a lead line electrically connecting the protective circuit module to the plurality of battery cells, and a connection tab including a body and an extending member. The body is electrically connected to the electrodes of the plurality of the battery cells and the extending member extends from the body. The extending member includes a lead-line soldering member having the lead line soldered thereto and a lead-line pressing member pressing on the lead line from above the lead-line soldering member.

### BACKGROUND

A battery pack may be manufactured by connecting a plurality of battery cells in series and/or parallel. The battery pack may be used in devices such as notebook computers and electric vehicles.

### SUMMARY

Embodiments may be realized by providing a battery pack that includes a plurality of battery cells having electrodes and the plurality of battery cells are arranged parallel to each other, a holder case accommodating the plurality of battery cells, a protective circuit module mounted on an outer surface of the holder case, a lead line electrically connecting the protective circuit module to the plurality of battery cells, and a connection tab including a body and an extending member. The body is electrically connected to the electrodes of the plurality of the battery cells and the extending member is extended from the body. The extending member includes a lead-line soldering member having the lead line soldered thereto and a lead-line pressing member pressing on the lead line from above the lead-line soldering member.

The lead-line pressing member may include a convex portion extending toward the lead-line soldering member. The holder case may expose the electrodes of the plurality of battery cells and may surround side surfaces of the plurality of battery cells. The extending member may include a first bending member bent toward the outer surface of the holder case from a surface parallel to the electrodes of the plurality of battery cells.

The lead-line soldering member may be on the outer surface of the holder case. The lead-line pressing member may extend in a direction vertical to an extended direction of the lead line soldering member. The lead-line pressing member may extend from an end portion of the lead-line soldering member.

The extending member may include a second bending member at a boundary between the lead-line pressing member and the lead-line soldering member. The extending member may include a step difference element between the second bending member and the lead-line pressing member. The step difference element may be arranged at an incline between the lead-line pressing member and the second bending member.

The lead line pressing member may be arranged substantially flat. The lead line may be a monitoring lead line for measuring cell balancing.

The body and the extending member may be integrally formed as one continuous piece that overlaps ends of the plurality of battery cells and the outer surface of the holder case. The lead-line soldering member and the lead-line pressing member may be integrally formed as one continuous piece that is bent such that the lead-line pressing member overlaps the lead-line soldering member and the lead line. The lead-line pressing member may include a protrusion integrally formed with the lead-line pressing member and in contact with the lead line.

The extending member may include a first bending member bent from the body and the first bending member may be adjacent to a corner of the holder case. The extending member may include a second bending member between the lead-line pressing member and the lead-line soldering member and the second bending member has a curved shape. The extending member may include a step difference element between the second bending member and the lead-line pressing member. The step difference element may be arranged at an incline relative to the lead-line pressing member. The lead-line pressing member and the lead-line soldering member may be arranged parallel to the holder case, and the step difference element may be arranged at the incline relative to both the lead-line pressing member and the lead-line soldering member.

The lead-line pressing member may overlap an entirety of a width of the lead-line soldering member. The lead-line pressing member may be a plate including an indentation and the indentation may be in contact with the lead line from above the lead-line soldering member. The width of the lead-line soldering member along a first direction and a width of the lead-line pressing member along the first direction may be greater than a width of the body along the first direction.

### BRIEF DESCRIPTION OF THE DRAWINGS

Features will become apparent to those of ordinary skill in the art by describing in detail exemplary embodiments with reference to the attached drawings in which:

FIG. 1A illustrates a front perspective view showing a battery pack according to an exemplary embodiment.

FIG. 1B illustrates a rear perspective view showing the battery pack according to the exemplary embodiment.

FIG. 2 illustrates a perspective view showing a connection tab according to an exemplary embodiment.

FIG. 3 illustrates an enlarged view of portion A in FIG. 1.

FIG. 4 illustrates a sectional view taken along a line B-B′ in FIG. 3.

FIG. 5 illustrates a perspective view showing a connection tab according to an exemplary embodiment.

FIG. 6 illustrates an enlarged perspective view showing an extending member of the connection tab according to an exemplary embodiment.

FIG. 7 illustrates a sectional view taken along a line C-C′ in FIG. 6.

### DETAILED DESCRIPTION

Korean Patent Application No. 10-2012-0011172, filed on Feb. 3, 2012, in the Korean Intellectual Property Office, and entitled: “Battery Pack” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of elements and regions may be exaggerated for clarity of illustration not necessarily drawn to scale. Like reference numerals refer to like elements throughout.

It will also be understood that when an element is referred to as being “on” another element, it can be directly on the other element, or intervening elements may also be present. Further, it will be understood that when an element is referred to as being “under” another element, it can be directly under, and one or more intervening elements may also be present. In addition, it will also be understood that when an element is referred to as being “between” two elements, it can be the only element between the two elements, or one or more intervening elements may also be present. Also, when an element is referred to as being “connected to” another element, it can be directly connected to the other element or be indirectly connected to the other element with one or more intervening elements interposed therebetween.

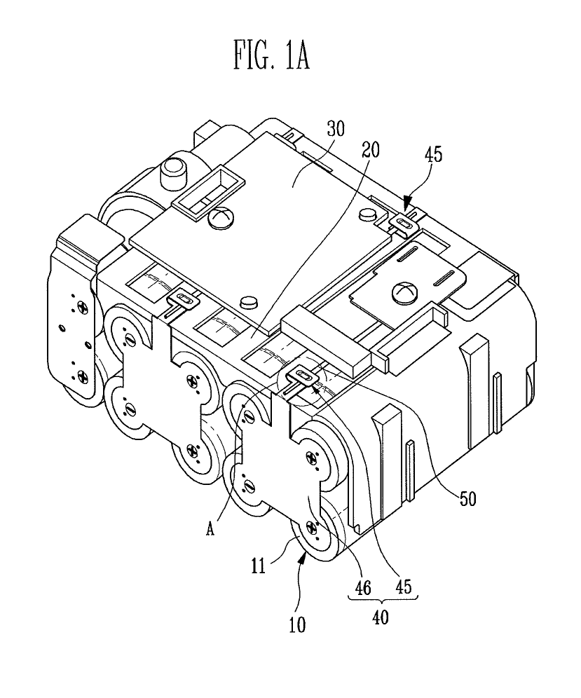

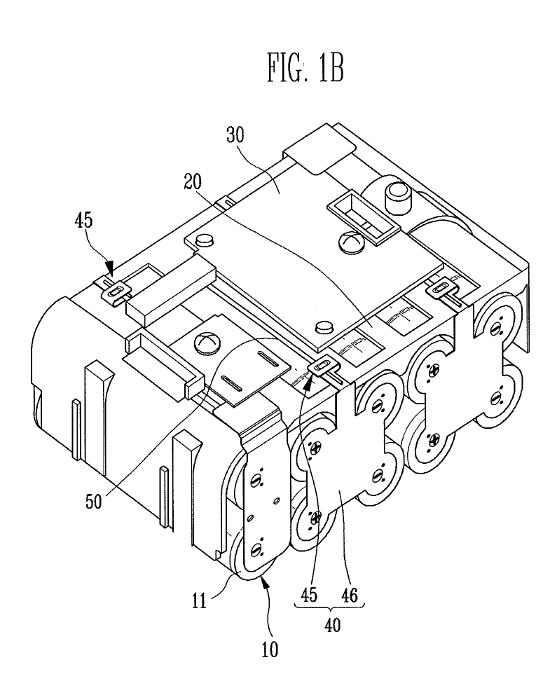

FIG. 1A illustrates a front perspective view showing a battery pack according to an exemplary embodiment. FIG. 1B illustrates a rear perspective view showing the battery pack according to the exemplary embodiment illustrated in FIG. 1A.

Referring to FIGS. 1A and 1B, the battery pack according to this exemplary embodiment may include a plurality of battery cells 10, a holder case 20, a protective circuit module 30, lead lines 50, and connection tabs 40. Each of the connection tabs 40 may include a body 46 and an extending member 45. The body 46 may be electrically connected to electrodes 11 of adjacent ones of, e.g., four adjacent ones of, the plurality of battery cells 10. The extending member 45 may extend from the body 46 so that the lead line 50 is connected, e.g., directly connected, to the extending member 45.

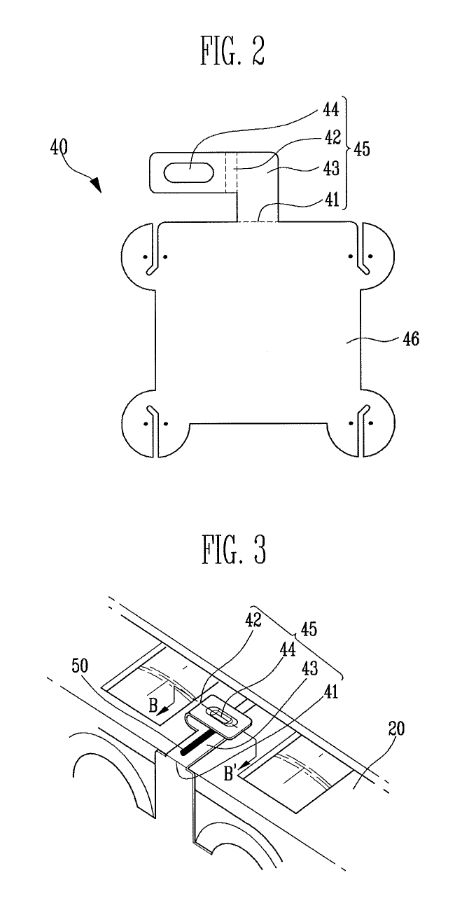

The extending member 45 may include a lead-line soldering member 43 (see FIG. 3) to which the lead line 50 is attached, e.g., soldered. The extending member 45 may include a lead-line pressing member 44 (see FIG. 3) that extends from the lead-line soldering member 43, e.g., form an end portion or a lateral side of the lead-line soldering member 43. The lead-line pressing member 44 may press on the lead line 50 from a direction above the lead-line soldering member 43. For example, the lead line 50 may be enclosed between the lead-line pressing member 44 and the lead-line soldering member 43.

A rechargeable cylindrical lithium-ion battery may be used as each of the plurality of battery cells 10. The plurality of battery cells 10 according to an exemplary embodiment may be arranged in a five-series and two-parallel structure (5S*2P). That is, five groups each having two battery cells 10 connected in parallel are connected in series by the connection tab 40. The connection tab 40 may be formed of a conductive material such as copper so as to electrically connect the battery cells 10 in the five groups. As one of ordinary skill in the art would understand, embodiments are not limited to the 5S*2P structure. For example, the structure may include a ten-series with four-parallel layout.

The connection relationship between the groups of the plurality of the battery cells will be described in detail with reference to FIGS. 1A and 1B. Two battery cells 10 may be basically connected in parallel to each other. One end of the battery cells 10 connected in parallel may have a first polarity, and the other opposing end of the battery cells 10 connected in parallel may have a second polarity. The first polarity is opposite the second polarity.

Referring to FIG. 1A, the first polarity ends of the battery cells 10 may be electrically connected in parallel to the protective circuit module 30 through the connection tab 40 positioned adjacent to the first polarity ends of the battery cells 10. Referring to FIG. 1B, the second polarity ends of the battery cells may be electrically connected in series to the first polarity ends of neighboring battery cells 10 through the connection tab 40. Accordingly, second polarity ends of the battery cells 10, which are connected in parallel to each other, may be electrically connected in series to the first polarity ends of neighboring battery cells 10.

As such, the battery cells 10 in the five groups are connected in series. The second polarity ends of the last group of battery cells 10 may be electrically connected to the protective circuit module 30 through a connection tab 40 positioned at the opposing side of the last group of battery cells 10. For example, the plurality of the battery cells 10 having two opposing ends are arranged substantially in parallel with one another in a first direction. Although the five-series and two-parallel structure (S5*2P) has been described, embodiments are not limited to that structure, and may be applied to various connection structures as occasion demands.

The holder case 20 may be formed to surround at least one portion of outer surfaces of the plurality of battery cells 10. The holder case 20 may expose the electrodes 11 formed at ends of the plurality of battery cells 10. The holder case 20 may surround side surfaces of the plurality of battery cells 10. For example, the holder case 20 may be formed as one integrally formed continuous piece or one assembled piece that surrounds upper and lower side surfaces of the of the plurality of battery cells 10 and the sides adjacent to the upper and lower sides. The holder case 20 may improve the durability of the battery pack in the event of, e.g., an external impact, drop, and/or vibration.

The protective circuit module 30 may be mounted on, e.g., directly on, an outer surface of the holder case 20. The protective circuit module 30 may overlap some of the plurality of battery cells 10. The protective circuit module 30 may have electronic components, etc., mounted thereon. The protective circuit module 30 may be configured to include a protection circuit, etc. In an exemplary embodiment, the protective circuit module 30 may be fixed to the holder case 20 through screw coupling. Alternatively, the circuit module 30 may be fixed to the holder case 20 by another fastening means such as by an interlocking arrangement therebetween.

The lead line 50 may be coated with a vinyl tube or the like. The lead line 50 may electrically connect the protective circuit module 30 and the plurality of battery cells 10 to each other. The lead line 50 may be a monitoring lead line capable of measuring cell balancing. One side of the lead line 50 may be connected to the connection tab 40, and the other side of the lead line 50 may be connected to the protective circuit module 30. For example, the one side of the lead line 50 may be connected to the connection tab 40 through soldering. Thus, it may be possible to check whether or not current flows well in the plurality of battery cells 10 through the lead line 50.

The connection tab 40 may include the body 46 electrically connected to the electrodes 11 of the plurality of battery cells 10. The extending member 45 may extend from a side of the body 46, e.g., may be bent from a lateral end of the body 46. The lead line 50 may be connected to the extending member 45. The extending member 45 may include the lead-line soldering member 43 therein (see FIG. 3). At least a portion of the lead line 50 may be soldered to the soldering member 43. The lead-line soldering member 43 may be a portion of the extending member 45 that is bent from the body 46 so that the lead-line soldering member 43 and the body 46 overlap different sides of the plurality of battery cells 10 and different sides of the holder case 20.

The extending member 45 may further include the lead-line pressing member 44 (see FIG. 3) that presses the lead line 50 from above the lead-line soldering member 43 when the lead line 50 is soldered to the connection tab 40. The lead-line pressing member 44 may extend from a sidewall of the lead-line soldering member 43 and may overlap at least a portion of the lead-line soldering member 43. For example, the lead-line pressing member 44 may overlap an entire width of the lead-line soldering member 43 and the portion of the lead line 50 soldered to the lead-line soldering member 43. The width of the lead-line soldering member 43 and a width of the lead-line pressing member 44 (in the direction of overlapping with the lead-line soldering member 43) may be greater than a width of the body 46.

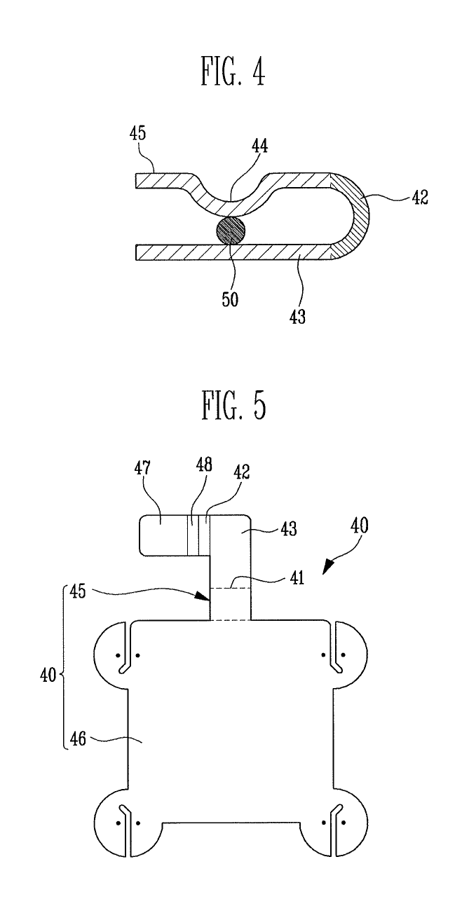

The lead-line soldering member 43 may be formed on, e.g., may be in contact with, an outer surface of the holder case 20. Accordingly, the lead-line soldering member 43 may be on a side surface of the battery cell 10. The lead-line pressing member 44 may be a plate, e.g., a conductive plate that extends from the lead-line soldering member 43, that includes an indentation. For example, the lead-line pressing member 44 may include a convexly formed portion, e.g., may have a convex protrusion, extending in a direction toward the lead-line soldering member 43 (see FIG. 4), which will be described in detail later.

FIG. 2 illustrates a perspective view showing a connection tab 40 according to an exemplary embodiment.

Referring to FIG. 2, the connection tab 40 may include the body 46 that is a region electrically connected to the electrodes 11 (see FIG. 1A) of ones of the plurality of battery cells 10 through, e.g., welding. The extending member 45 may have a width, e.g., along a first direction, that is narrower than a width, e.g., also along the first direction, of the body 46 so that the extending member 45 extends, e.g., is bend directly, from a portion of one lateral end of the body 46 in one direction from the body 46. The extending member 45 may be a region in which one side of the lead line 50 (see FIG. 1A) is soldered thereto. Accordingly, the plurality of battery cells 10 and the protective circuit module 30 can be electrically connected to each other via the extending member 45.

The extending member 45 may include the lead-line soldering member 43 and the lead-line pressing member 44. Here, the lead-line soldering member 43 is extended from, e.g., bent from, the body 46 so that the lead line 50 is soldered thereto. The lead-line pressing member 44 may be integrally formed with the lead-line soldering member 43 so as to extend in the direction vertical to the extended direction of the lead-line soldering member 43 from an end portion of the lead-line soldering member 43.

Referring to FIG. 2, a first bending member 41 may be formed in the extending member 45 so as to be bent toward the outer surface of the holder case 20 from a surface parallel to the electrodes 11 of the battery cells 10. Both the lead-line soldering member 43 and the lead-line pressing member 44 may be positioned on the holder case 20. The first bending member 41 may correspond to a corner of the holder case 20. The first bending member 41 may be integrally formed as one continuous piece with the body 46 or may be affixed to the body 46.

A second bending member 42 may be formed between the lead-line soldering member 43 and the lead-line pressing member 44. Accordingly, the second bending member 42 may be bent so that the lead-line pressing member 44 may be positioned above the lead-line soldering member 43. The second bending member 42 may be integrally formed as one continuous piece with the lead-line soldering member 43 and the lead-line pressing member 44. For example, the second bending member 42, the lead-line soldering member 43, and the lead-line pressing member 44 may each be formed of a conductive material such as a metal plate.

The second bending member 42 may have a height sufficient enough to separate portions of the lead-line soldering member 43 and the lead-line pressing member 44 by a predetermined distance. As such, portions of the lead-line pressing member 44 may be spaced apart along the horizontal direction from the lead-line soldering member 43. The lead-line pressing member 44 may include a convexly formed portion that extends in a direction toward the lead-line soldering member 43, e.g., so that a lowermost portion of the lead-line pressing member 44 may be pressed on the lead line 50 (see FIG. 4).

FIG. 3 illustrates an enlarged view of portion A in FIG. 1. FIG. 4 illustrates a sectional view taken along a line B-B′ in FIG. 3. FIG. 5 illustrates a perspective view showing a connection tab 40. FIGS. 3-5 illustrate connection tabs 40 according to exemplary embodiments. The connection tabs 40 illustrated in FIGS. 3-5 are similar to the connection tab 40 illustrated in FIG. 2 and differences therebetween will be mainly described.

Referring to FIGS. 3 and 4, the first bending member 41 may be bent toward the outer surface of the holder case 20 from a surface of the body 46 parallel with the electrodes 11 at the ends of battery cells 10. The first bending member 41 may be formed in one region of the extending member 45 of the connection tab 40. For example, the one region of the extending member 45 may extend directly from the body 46, e.g., may be integrally formed as one continuous piece with the body 46, and may be parallel with the ends of the battery cells 10. The one region of the extending member 45 extending directly from the body 46 may have a width that is smaller than a width of the body 46. The lead-line soldering member 43 may have a width that is the same as the one region of the extending member 45 extending directly from the body (see FIG. 5) or a width that is less than the one region of the extending member 45 (see FIG. 3). The extending member 45 may extend toward a corner of the holder case 20 so that the first bending member 41 is adjacent to and/or corresponds to the corner of the holder case 20.

Based on the first bending member 41 as a boundary, a side of the extending member 45 connected to the body 46 may be positioned adjacent to the electrodes 11 at the ends of the battery cells 10. Further, the lead-line soldering member 43 and the lead-line pressing member 44 may be positioned on the side surface of at least one of the battery cells 10, e.g., on the outer surface of the holder case 20.

The lead-line pressing member 44 may be extended in a direction vertical to the extended direction of the lead-line soldering member 43 from the end portion of the lead-line soldering member 43. The second bending member 42 may be formed at the boundary between the lead-line pressing member 44 and the lead-line soldering member 43. Thus, the second bending member 42 may be bent so that the lead-line pressing member 44 is positioned above the lead-line soldering member 43. The second bending member 42 may have a curved shape or may include at least two bent regions.

Referring to FIG. 4, the lead line 50 may be mounted on the lead-line soldering member 43 and then pressed by the lead-line pressing member 44 positioned above the lead-line soldering member 43. The lead-line pressing member 44 may have a protrusion portion, e.g., the convexly formed portion, that extends toward the lead line 50 from above. Accordingly, the lead line 50 may be under the protrusion portion of the lead-line pressing member 44. The shape of the protrusion in the lead-line pressing member 44 may be varied, e.g., the shape may be prismatic, cubic, cylindrical, etc. A lowermost portion of the lead-line pressing member 44, which lowermost portion may correspond to a lowermost portion of a convexly formed portion, may press on the lead line 50 from above. Accordingly, the lead line 50 may be fixed to the lead-line soldering member 43 by soldering and the lead-line pressing member 40.

According to exemplary embodiments, based on the lead-line pressing member 44, the lead line 50 may not move during a soldering process and the failure rate of soldering may be minimized. For example, the lead-line pressing member 44 may have a central portion including a protrusion, e.g., a protrusion that is convexly formed, extending toward the lead-line soldering member 43 and the lead line 50. The protrusion of the lead-line pressing member 44 may overlap an entire width of the lead line 50 and at least a portion of the lead-line soldering member 43. The second bending member 42 may be bent so that the interval, e.g., a predetermined distance, between the lead-line soldering member 43 and the lead-line pressing member 44 is at least as much as or less than a diameter of the lead line 50.

The lead line 50 may be entirely coated with an insulation material such as a vinyl tube. The coating at only the end portion of the lead line 50 contacting the lead-line soldering member 43 may be stripped off so that the lead line 50 may be soldered to the connection tab 40. Accordingly, the end portion of the lead line 50 may be soldered to the lead-line soldering member 43 of the connection tab 40 and thus may be electrically connected to each other.

As described in this embodiment, the lead-line pressing member 44 may be formed in the connection tab 40, so that the lead line 50 may be easily fixed. Further, another lead line 50 may not be damaged by the connection tab 40, and thus it may be possible to reduce the possibility of and/or prevent a short circuit between the lead line 50 and the connection tab 40.

Referring to FIG. 5, the connection tab 40 according to this exemplary embodiment includes the body 46 connected to the electrodes 11 of one of the battery cells 10, and an extending member 45 extending in a direction from the body 46. The extending member 45 may be a region in which one side of the lead line 50 (See FIG. 1A) is soldered thereto. Accordingly, the plurality of battery cells 10 and the protective circuit module 30 may be electrically connected to each other through the extending member 45.

The extending member 45 may be formed with the lead-line soldering member 43 extended from the body 46 so that the lead line 50 is soldered thereto. The lead-line pressing member 44 may extend in a direction vertical to the extending direction of the lead-line soldering member 43 from an end portion of the lead-line soldering member 43. The first bending member 41 formed in the extending member 45 may be bent toward the outer surface of the holder case 20 from the surface parallel with the electrodes 11 of the battery cells 10.

A second bending member 42 may be formed between the lead-line soldering member 43 and the lead-line pressing member 44. A step difference element 48 may be formed between the second bending member 42 and the lead-line pressing member 44. The step difference element 48 may be inclined to be gradually lowered toward the lead-line pressing member 44 from the second bending member 42, e.g., from an end portion of the second bending member 42, in the state in which the second bending member 42 is bent. The lead-line pressing member 44 may be positioned above the lead-line soldering member 43 by bending the second bending member 42. In this case, the lead-line pressing member 44 may be foamed substantially flat, e.g., a portion of the lead-line pressing member 44 that surrounds the convexly formed portion may be substantially flat and/or may be arranged substantially flat.

The interval between the lead-line soldering member 43 and the lead-line pressing member 44 can be adjusted by the step difference element 48 formed between the second bending member 42 and the lead-line pressing member 44.

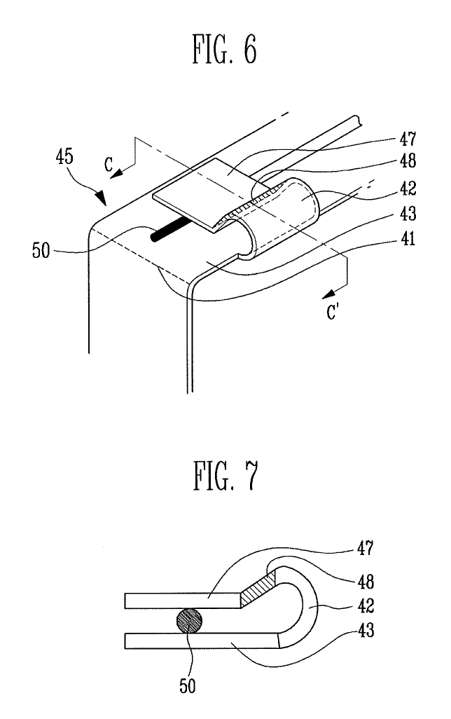

FIG. 6 illustrates an enlarged perspective view showing an extending member of the connection tab according to an exemplary embodiment that includes the step different element 48. FIG. 7 illustrates a sectional view taken along a line C-C′ in FIG. 6.

Referring to FIGS. 6 and 7, the first bending member 41, in one region of the extending member 45 of the connection tab 40, may be bent toward the outer surface of the holder case 20 from the surface parallel with the electrodes 11 of the battery cells 10 is formed. Accordingly, based on the first bending member 41 as a boundary, the side connected to the body 46 may be positioned at the side of the electrodes 11 of the battery cells 10, and the lead-line soldering member 43 and the lead-line pressing member 44 may be positioned on the side surface of at least one of the battery cells 10, e.g., on the outer surface of the holder case 20.

The lead-line pressing member 44 may be extended in a direction vertical to the extended direction of the lead-line soldering member 43 from the end portion of the lead-line soldering member 43. The second bending member 42 may be formed at the boundary between the lead-line pressing member 44 and the lead-line soldering member 43. The second bending member 42 may have a curved shaped. Thus, the second bending member 42 may be bent so that the lead-line pressing member 44 may be positioned above the lead-line soldering member 43.

The step difference element 48 may be formed between the second bending 42 and the lead-line pressing member 44. The step difference element 48 may be inclined to be gradually lowered toward the lead-line pressing member 44 from the second bending member 42. The step difference element 48 may also be inclined relate to an end portion of the second bending member 42. The shape of the step difference element 48 may be different from the shape of the second bending member 42. For example, the step difference element 48 may form an inclined surface having a constant slope and the second bending member 42 may have a curved shape having a changing slope.

The lead-line pressing member 44 and the lead-line soldering member 43 may be arranged substantially flat, e.g., may not be arranged at an incline so as to be level with the holder case 20. The lead-line soldering member, the second bending member 42, the step difference element 48, and the lead-line pressing member 44 may be integrally formed as one continuous piece or at least one may be affixed to the others. The lead-line soldering member 43, the second bending member 42, the step difference element 48, and the lead-line pressing member 44 may each be formed of a conductive material such as a metal plate that may be bent to form the second bending member 42 and the step difference element 48.

The lead line 50 may be mounted on the lead-line soldering member 43 and then pressed by the lead-line pressing member 44 positioned above the lead-line soldering member 43. Thereby the lead line 50 may be fixed by soldering and the lead-line pressing member 44. In this case, the lead-line pressing member 44 may be substantially flat. The interval between the lead-line soldering member 43 and the lead-line pressing member 44 may be varied due to the the slope of the step difference element 48, which is formed between the lead-line pressing member 44 and the second bending member 42. Accordingly, the lead-line pressing member 44 may press and fix the lead line 50 so that the lead line 50 may not move during a soldering process, thereby minimizing the failure rate of soldering.

Although the cylindrical battery cell has been used in the exemplary embodiments, it will be apparent that other battery cells having various other shapes such as a polyhedron shape and a prismatic shape may be used.

By way of summation and review, in a battery pack, individual battery cells may be electrically connected to neighboring battery cells by a connection tab. For example, a groove formed in the connection tab may have a lead line inserted therein to provide an electrical connection. However, the lead line may move, e.g., to the outside of the groove, during a soldering process between the connection tab and the lead line. A hook method may be used to fix the lead line in place, e.g., a hook may be provided in an outer case, but the hook method increases injection molding costs. Further, another lead line may be damaged by the connection tab and a corner of the groove, and a short circuit between the lead lines may occur.

Exemplary embodiments relate to a battery pack capable of improving safety by reducing the possibility of and/or preventing a short circuit. Embodiments also relate to a battery pack that may enable a lead-line pressing member to stably fix a lead line by forming a lead-line pressing member in a connection tab. For example, a lead-line pressing member may be formed in a connection tab and it may be possible to enhance reliability in a soldering process and safety against the occurrence of a short circuit. Further, the lead line may be simply fixed by the lead-line pressing member without, e.g., a complicated structure of a mold and/or a groove in the connection tab, thereby reducing costs. Embodiments also relate to a battery pack that may reduce the possibility of the connection tab damaging another lead line, thereby preventing a short circuit between connection tabs.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a plurality of battery cells having electrodes, the plurality of battery cells being arranged parallel to each other;
a holder case accommodating the plurality of battery cells;
a protective circuit module mounted on an outer surface of the holder case;
a lead line electrically connecting the protective circuit module to the plurality of battery cells; and
a connection tab including a body and an extending member, the body being electrically connected to the electrodes of the plurality of the battery cells, and the extending member extending from the body,
the extending member including a lead-line soldering member having the lead line soldered thereto and a lead-line pressing member pressing on the lead line from above the lead-line soldering member.

2. The battery pack as claimed in claim 1, wherein the lead-line pressing member includes a convex portion extending toward the lead-line soldering member.

3. The battery pack as claimed in claim 1, wherein the holder case exposes the electrodes of the plurality of battery cells and surrounds side surfaces of the plurality of battery cells.

4. The battery pack as claimed in claim 3, wherein the extending member includes a first bending member bent toward the outer surface of the holder case from a surface parallel to the electrodes of the plurality of battery cells.

5. The battery pack as claimed in claim 1, wherein the lead-line soldering member is on the outer surface of the holder case.

6. The battery pack as claimed in claim 1, wherein the lead-line pressing member extends in a direction vertical to an extended direction of the lead-line soldering member, the lead-line pressing member extending from an end portion of the lead-line soldering member.

7. The battery pack as claimed in claim 1, wherein the extending member includes a second bending member at a boundary between the lead-line pressing member and the lead-line soldering member.

8. The battery pack as claimed in claim 7, wherein the extending member includes a step difference element between the second bending member and the lead-line pressing member.

9. The battery pack as claimed in claim 8, wherein the step difference element is arranged at an incline between the lead-line pressing member and the second bending member.

10. The battery pack as claimed in claim 8, wherein the lead-line pressing member is arranged substantially flat.

11. The battery pack as claimed in claim 1, wherein the lead line is a monitoring lead line for measuring cell balancing.

12. The battery pack as claimed in claim 1, wherein the body and the extending member are integrally formed as one continuous piece that overlaps ends of the plurality of battery cells and the outer surface of the holder case.

13. The battery pack as claimed in claim 1, wherein the lead-line soldering member and the lead-line pressing member are integrally formed as one continuous piece that is bent such that the lead-line pressing member overlaps the lead-line soldering member and the lead line.

14. The battery pack as claimed in claim 1, wherein the lead-line pressing member includes a protrusion integrally formed with the lead-line pressing member and in contact with the lead line.

15. The battery pack as claimed in claim 7, wherein the second bending member has a curved shape.

16. The battery pack as claimed in claim 8, wherein the lead-line pressing member and the lead-line soldering member are arranged parallel to the holder case, and the step difference element is arranged at the incline relative to both the lead-line pressing member and the lead-line soldering member.

17. The battery pack as claimed in claim 1, wherein the lead-line pressing member overlaps an entirety of a width of the lead-line soldering member.
